(19) United States
(12) Patent Application Publication
(10) Pub. No.: US 2008/0300866 A1
(43) Pub. Date: Dec. 4, 2008

(54) METHOD AND SYSTEM FOR CREATION AND USE OF A WIDEBAND VOCODER DATABASE FOR BANDWIDTH EXTENSION OF VOICE

(75) Inventors: ADEEL MUKHTAR, CORAL SPRINGS, FL (US); DEEPAK P. AHYA, PLANTATION, FL (US)

Correspondence Address: AKERMAN SENTERFITT, P.O. BOX 3188, WEST PALM BEACH, FL, 33402-3188, US

(73) Assignee: MOTOROLA, INC., SCHAUMBURG, IL (US)

(21) Appl. No.: 11/421,420

(22) Filed: May 31, 2006

(51) Int. Cl. G10L 21/00

(52) U.S. Cl. 704/205; 704/E21.001

(57) ABSTRACT

The invention concerns a system (300) and method (400) for bandwidth extension of voice for improving the quality of voice in a communication system. The method and system include the steps of filtering (402) a wideband voice signal to produce a first filtered signal (301) and a second filtered signal (331), vocoding (404) the first filtered signal to produce a narrowband vocoded signal (130), compensating (406) the second filtered signal for time alignment with the narrowband vocoded signal, and adding (335) the narrowband vocoded signal with the second filtered signal to produce a wideband vocoded signal (250). One or more features from the wideband vocoded signal can be extracted to create a wideband feature vector (147) for storage in a wideband vocoded speech database (220).

### FIELD OF THE INVENTION

This invention relates in general to extending voice bandwidth and more particularly, to extending narrowband voice signals to wideband voice signals.

### BACKGROUND

The use of portable electronic devices has increased dramatically in recent years. The primary purpose of cellular phones is for voice communication. A cellular phone operates on voice signals by compressing voice and sending the voice signals over a communications network. The compression reduces the amount of data required to represent the voice signal and intentionally reduce the voice bandwidth. The voice bandwidth on a cellular phone is generally band limited to between 200 Hz and 4 KHz, whereas natural spoken voice resides within a bandwidth between 20 to 10 KHz. The voice band-limiting associated with the compression provides for more efficient transmission and reception of digital signals in a cellular communication system. The voice band-limiting is part of the compression which reduces the amount of data and processing required to transmit and receive a voice signal over a cellular communication channel. Communication networks are allocated a certain amount of bandwidth for which they can utilize the bandwidth spectrum to transmit and receive voice data.

Voice is the composition of many frequency components spanning the natural voice bandwidth of 20 to 20 KHz. As is known in the art, vocoders can compress voice. The compressed voice (i.e. vocoded voice) sufficiently preserves the original voice character and intelligibility even though it does not include all the frequency components of the original voice. Vocoding also introduces quantization effects which reduce the dynamic range of the voice and the overall voice quality. Moreover, Vocoding can inherently remove the low frequency regions of voice as well as the high frequency regions of voice. An analysis of vocoded voice reveals that the low frequency and high frequency components of speech are missing in comparison to the original voice signal that underwent the compression.

Compressing the voice bandwidth is a standard vocoding technique used in the voice communication industry to reduce the amount of data necessary to allow for efficient voice communication. However, the resulting bandwidth is less than the natural bandwidth of voice and results in inferior subjective audio quality and reduced intelligibility compared to wideband speech. Accordingly, wideband speech, having a bandwidth at least approximating the natural voice bandwidth, is desirable for enhanced audio quality.

Speech processing techniques such as Voice Bandwidth Extension have been tested and applied in an attempt to restore the missing low frequency and high frequency voice components. These techniques are generally applied to bandlimited speech that is non-vocoded. That is, certain frequency components are absent, though the voice has not been vocoded. Voice Bandwidth Extension techniques on non-vocoded speech can restore voice in those regions of voice, which are absent from the bandlimited voice in comparison to the original non-vocoded voice. Methods of Voice Bandwidth Extension include techniques which determine how the missing low frequency and high frequency voice components can be restored based on differences between the original non-vocoded voice signal and bandlimited non-vocoded voice. However, applying Voice Bandwidth Extension to vocoded speech based on mapping functions generated from non-vocoded voice can lead to artifacts and reduction in perceived audio quality.

### SUMMARY OF THE INVENTION

Embodiments of the invention are directed to a system and method for creating and using a wideband vocoder voice database. The wideband vocoder voice database can be employed in a bandwidth extension system for training mapping functions on wideband features of vocoded voice. The method can include filtering a wideband voice signal to produce a first filtered signal and a second filtered signal, vocoding the first filtered signal to produce a narrowband vocoded signal, adding the narrowband vocoded signal with the second filtered signal to produce a wideband vocoded signal, comparing wideband vocoded features of the wideband vocoded signal with wideband features of the wideband voice signal, and generating a mapping function based on one or more statistical differences between the wideband vocoded features and the wideband features. One or more features from the wideband vocoded signal can be extracted to create a wideband feature vector for storage in the wideband vocoded speech database. The method can also evaluate a speech quality difference between a narrowband vocoded voice signal and a wideband vocoded voice signal to determine an upper-bound voice quality based on the speech quality difference.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 illustrates a system for artificially extending the bandwidth of narrowband vocoded voice in accordance with an embodiment of the inventive arrangements;

FIG. 2 illustrates the system of FIG. 1 for bandwidth extension of narrowband vocoded voice in accordance with an embodiment of the inventive arrangements;

FIG. 3 illustrates a mapping function for converting a set of narrowband coefficients to a set of wideband coefficients in accordance with an embodiment of the inventive arrangements;

FIG. 4 illustrates system for mapping features during training and applying the mapping in accordance with an embodiment of the inventive arrangements;

FIG. 5 illustrates a block diagram for creating wideband vocoded voice signals suitable for use in training in accordance with an embodiment of the inventive arrangements;

FIG. 6 illustrates a method for creating wideband vocoded voice signals corresponding to the block diagram of FIG. 5 in accordance with an embodiment of the inventive arrangements;

FIG. 7 illustrates further components of the block diagram of FIG. 5 in accordance with an embodiment of the inventive arrangements; and

FIG. 8 illustrates a narrowband voice spectrum and wideband voice spectrum in accordance with an embodiment of the inventive arrangements.

### DETAILED DESCRIPTION OF THE INVENTION

While the specification concludes with claims defining the features of the invention that are regarded as novel, it is believed that the invention will be better understood from a consideration of the following description in conjunction with the drawing figures, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The terms “program,” “software application,” and the like as used herein, are defined as a sequence of instructions designed for execution on a computer system. The term “suppress” can be defined as reducing or removing, either partially or completely. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system. The term “processor” can be defined as any number of suitable processors, controllers, units, or the like that carry out a pre-programmed or programmed set of instructions.

The term “narrowband signal” can be defined as a signal having a bandwidth corresponding to a telephone bandwidth of approximately 200 Hz to 4 KHz. The term “wideband signal” can be defined as a signal having a bandwidth that is greater than a narrowband signal. A “narrowband vocoded signal” can be defined as a vocoded signal having a bandwidth corresponding to a vocoder bandwidth of approximately 200 Hz to 4 KHz. A “wideband vocoded signal” can be defined as a narrowband vocoded signal that is artificially extended to include either, or both, low frequency components and high frequency components. The low frequency components and high frequency components may be vocoded or not vocoded. The term “wideband vocoded features” can be defined as features extracted from a wideband vocoded signal. The term “wideband features” can be defined as features extracted from a non-vocoded signal, such as PCM speech. The term mapping function can be defined as a mathematical based hardware of software algorithm that translates a first feature set into a second feature set.

Embodiments of the invention concern a method of training voice bandwidth extension systems based on wideband feature mappings generated from a wideband vocoded database. The method can include comparing wideband vocoded features of a wideband vocoded signal with wideband features of a wideband voice signal, and generating a mapping function based on one or more statistical differences between the wideband vocoded features and the wideband features. The mapping function can describe changes to narrowband vocoded signals for extending a bandwidth of the narrowband vocoded signal to generate the wideband vocoded signal.

Embodiments of the invention also concern a system for extending the bandwidth of narrowband voice. The system can employ mapping functions derived from a pattern recognition training using the wideband vocoded voice database. The system can include a decoder for receiving a narrowband vocoded voice signal, and a processor for converting the narrowband vocoded voice signal to a wideband vocoded voice signal based on one or more mapping functions created during a training of a wideband vocoded voice database. The processor can map one or more narrowband features of the narrowband vocoded voice signal to one or more wideband features. In one arrangement, the processor can extend a set of narrowband reflection coefficients to a set of wideband reflection coefficients using one of the mapping functions for generating a wideband vocoded spectral envelope. The wideband vocoded spectral envelope can be combined with a wideband vocoded excitation signal to generate a wideband voice signal.

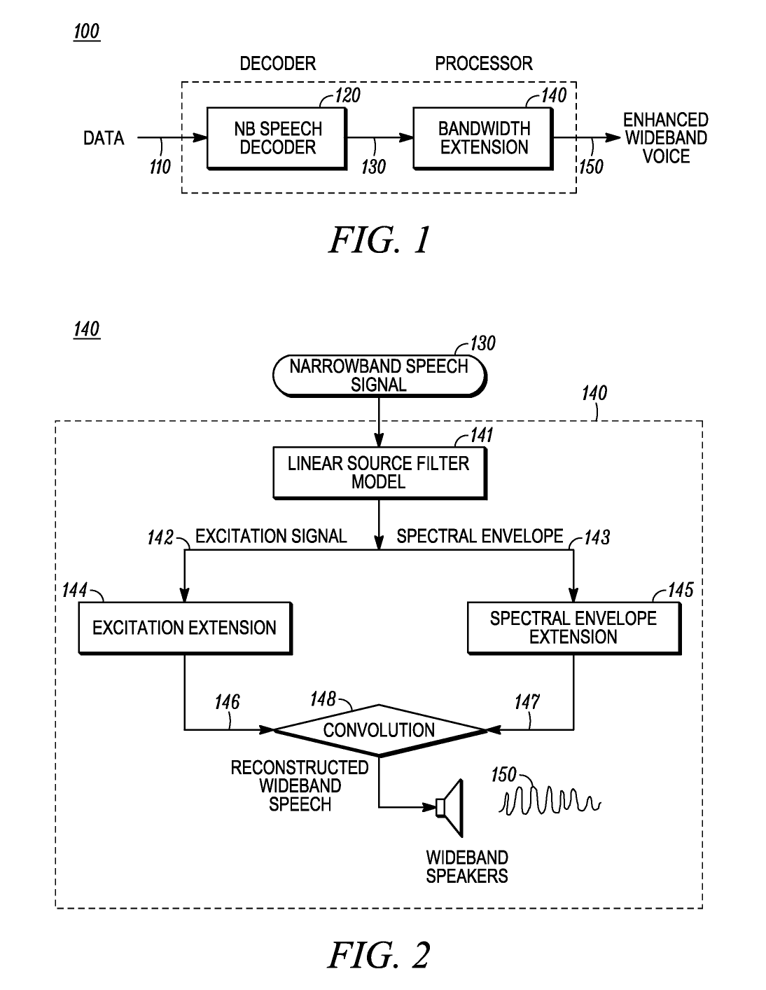

Referring to FIG. 1, a system 100 for artificially extending the bandwidth of vocoded speech is shown. The system 100 can include a decoder 120 for decoding data into vocoded voice, and a bandwidth extension module (BWE) 140 for extending the bandwidth of the vocoded voice to produce wideband (WB) voice. The system 100 can include a modem (not shown) with a transmit connection and a receive connection for sending and receiving packets of data 110 representing voice. The narrowband speech decoder 120 can receive packets of data 110 from the modem. For example, the modem can demodulate a communications signal into the stream of data packets 110. Each of the data packets can represent vocoded voice. The narrowband speech decoder 120 can decode the data packets 110 into a narrowband (NB) vocoded voice signal 130. The NB vocoded voice signal 130 may have a voice bandwidth of N which can be associated with a sampling bandwidth 2N used during the vocoding of the voice signal during encoding. In particular, the BWE 140 can apply mapping functions to transform the NB vocoded voice signal 130 to a wideband (WB) vocoded voice signal 150. For example, the bandwidth extension module 140 can extend the voice bandwidth from N to 2N.

As is known in the art, voice can undergo an encoding and decoding process referred to as vocoding that compresses the size of data required to represent the voice. The decoding can be performed by the decoder 120. For example, an 8 KHz vocoder can reduce a storage of 16 KHz sampled voice by a factor of two. However, the encoding process reduces the voice bandwidth to achieve the higher compression which results in a decoded signal 130 having half the bandwidth of the original voice. Accordingly, the BWE 140 can extend the bandwidth of voice beyond the bandwidth associated with the bandwidth of the decoder 120 to restore the voice bandwidth to the range prior to vocoding. For example, the decoder 120 may have a maximum fixed sample rate of 8 KHz which places a theoretical limit on the frequency range of the decoded voice at a bandwidth of 4 KHz. This is the Nyquist Theorem, and states that the maximum reconstructed bandwidth is half of the sampling frequency. The BWE 140 can extend the band-limited voice up to 8 KHz as will be discussed ahead. The BWE 140 can restore the missing high and low frequencies of narrowband (NB) voice 130 by extrapolating features to derive wideband (WB) voice 150 which results in improved audio quality of the handset. The BWE 140 as applied to narrowband voice 130 at an output of the speech decoder 120 can enhance speech quality.

The decoder 120 and the BWE 140 can be implemented in a processor, such as one or more microprocessors, microcontrollers, digital signal processors (DSPs), combinations thereof or such other devices known to those having ordinary skill in the art, that is in communication with one or more associated memory devices, such as random access memory (RAM), dynamic random access memory (DRAM), and/or read only memory (ROM) or equivalents thereof, that store data and programs that may be executed by the processor. The system 100 can be included in a communication device such as a cell phone, a handset, a radio, a personal digital assistant, a portable media player and the like.

The system 100 can include a communications module (not shown), for communicating with one or more communication networks such as a WLAN network, or a cellular network including, but not limited to, GSM, CDMA, iDEN, OFDM, WiDEN, and the like. In practice, the system 100 can provide wireless connectivity over a radio frequency (RF) communication network or a Wireless Local Area Network (WLAN). Communication within the network 100 can be established using a wireless, copper wire, and/or fiber optic connection using any suitable protocol (e.g., TCP/IP, HTTP, etc.). The system 100 can also connect to the Internet over a WLAN. Wireless Local Access Networks (WLANs) provide wireless access within a local geographical area. In typical WLAN implementations, the physical layer uses a variety of technologies such as 802.11b or 802.11g WLAN technologies. The physical layer may use infrared, frequency hopping spread spectrum in the 2.4 GHz Band, or direct sequence spread spectrum in the 2.4 GHz Band.

Referring to FIG. 2, a more detailed block diagram of the BWE 140 of FIG. 1 is shown. In one arrangement, the bandwidth extension module 140 can include a linear source filter model 141 to generate an excitation signal 142 and a spectral envelope 143 from the NB speech signal 130. The linear source filter model 141 can employ Linear Predictive Coding (LPC) techniques to derive an all-pole approximation to the NB speech signal. As is known in the art, a Fourier Transform of an all-pole model containing the LPC coefficients can represent the spectral envelope 143. The NB speech signal 130 can be passed through the all-pole filter to generate the NB excitation signal 142. An excitation extension module 144 can extend the bandwidth of the NB excitation signal 142 to generate a WB excitation signal 146. For example, low frequency components and high frequency components of the NB excitation signal 142 can be generated for producing the WB excitation signal 146. A spectral envelope extension module 145 can extend the bandwidth of NB spectral envelope 143 to generate a WB spectral envelope 147. For example, low frequency components and high frequency components of the NB spectral envelope 142 can be generated to produce the WB spectral envelope 147. The bandwidth extension module 140 can include a convolution operator 148 to convolve the WB excitation signal 146 with the wideband spectral envelope 147 for producing the WB vocoded voice signal 150.

In particular, the spectral envelope extension module 145 can apply mapping functions for converting one or more LPC features of the NB voice signal 130 to LPC features of the WB voice signal 147. The mapping function can translate features of the NB spectral envelope to corresponding features of the WB spectral envelope. The LPC features can be from the set of reflection coefficients, cepstral coefficients, Mel cepstral coefficients, but are not limited to these. Various feature sets can be derived from the LPC features which are suitable for applying mapping functions. The mapping functions can be generated during a training phase which associates changes in the features of a NB voice signal with changes in features of a corresponding WB voice signal.

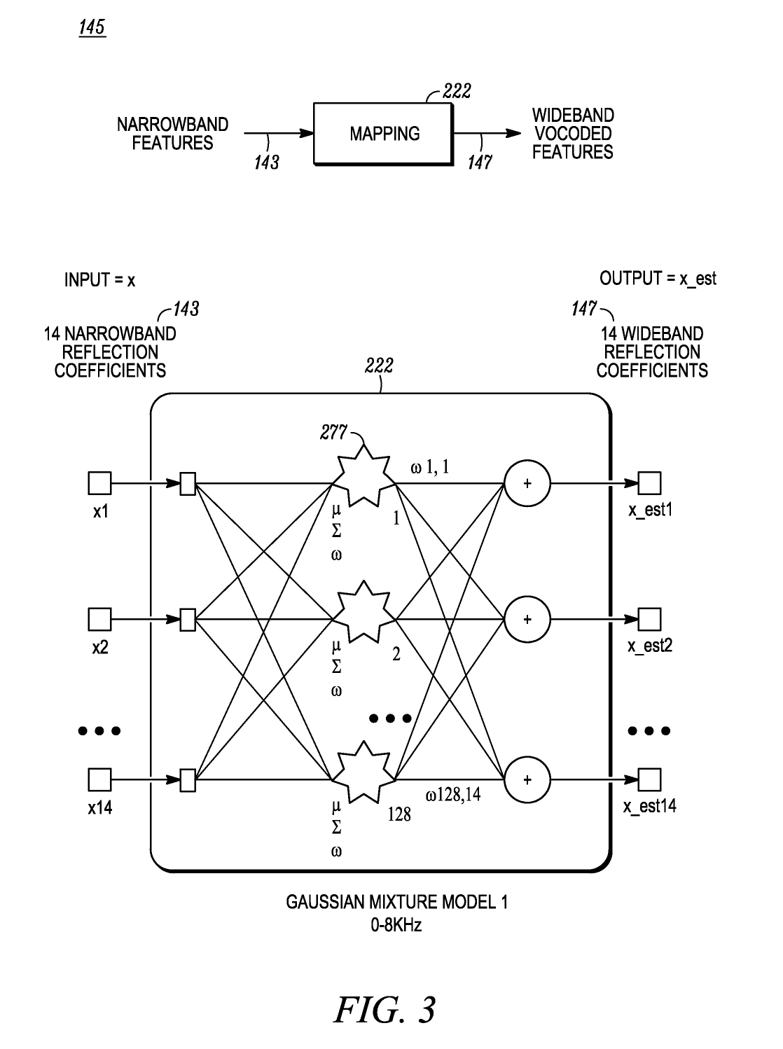

For example, referring to FIG. 3, a Gaussian Mixture Model (GMM) 222 provides a mapping between NB coefficients 143 (representing the NB spectral envelope) and WB coefficients 147 (representing the WB spectral envelope) is shown. As an example, the GMM 222 can comprise 128 Gaussians that are mixed together based on the characteristics NB features 143 which are shown as reflection coefficients. Each Gaussian 277 can be represented by a set of parameters μ, Σ, ω describing the statistics of a single Gaussian, where, the input feature vector x can be the RC coefficient vector of length 14×1, μ is the mean RC coefficient vector of length 14, Σ is the covariance matrix of size 14×14 for the 14 RC coefficients, and ω are the mixing weights. Each Gaussian 277 captures a portion of the total statistical information contained in the mappings between NB and WB reflection coefficients.

GMMs can be useful in statistical modeling applications in which information that represents the general characteristics or trends must be extracted from a large amount of data. Mapping functions such as GMMs are useful in gaining statistical insight of large quantities of data and for applying the statistical information. It should be noted that Gaussian Mixture Models (GMM) are merely one example of a mapping function. Those of skill in the art will appreciate that there are different ways to implement mapping functions such as Vector Quantization, or Hidden Markov Models.

During training, the GMM 222 learns an optimal transformation, known as a mapping, which can be applied to a NB voice signal to convert it to a WB voice signal in accordance with the statistical information provided by the GMM 222 based on the learning. It should be noted, that the GMM 222 provides statistical modeling capabilities based on the learning during training. For example, in practice, the GMM 222 can be presented off-line with input and output training data to learn statistics associated with the input to output data transformations of the NB features and WB features. In one arrangement, the GMM 222 can employ an Expectation-Maximization (EM) algorithm to learn the mapping between the NB features (143) and WB features (147)

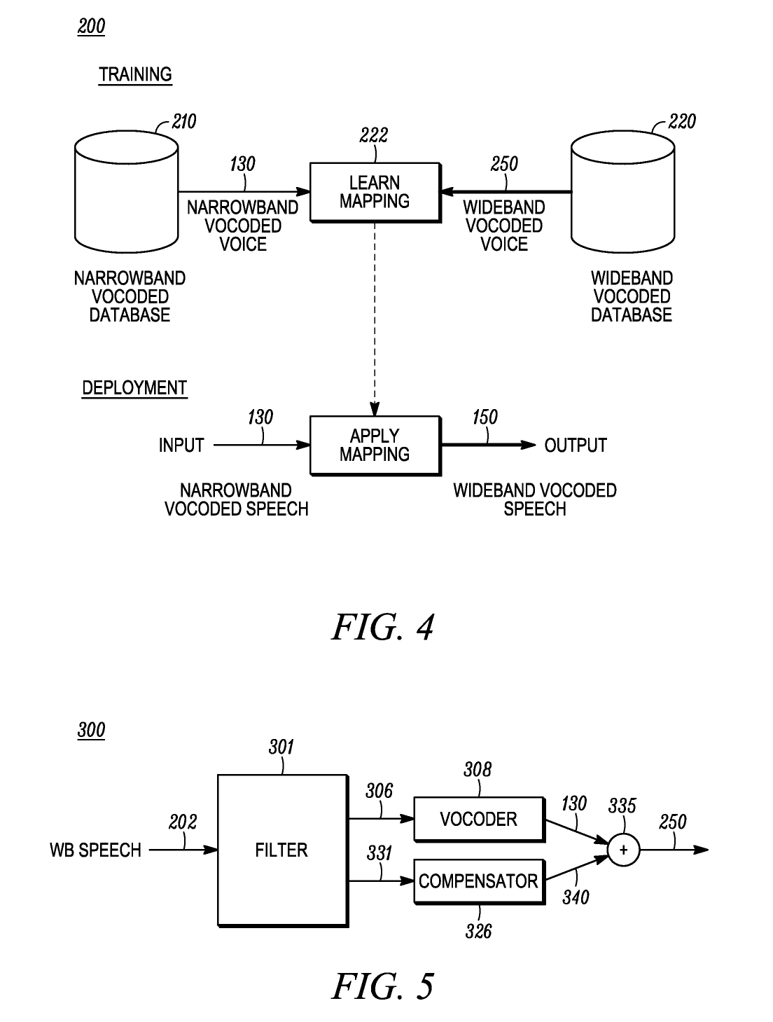

Referring to FIG. 4, a system 200 for mapping features during training and applying the mappings is shown. The system 200 can include a NB vocoder voice database 210 for storing a plurality of NB vocoded voice signals and a WB vocoded voice database 220 for storing a plurality of WB vocoded voice signals. NB voice signals within the NB database can have a bandwidth of 300 Hz to 3.6 KHz and WB voice signals within the WB database can have a bandwidth of 50 Hz to 8 KHz. NB and WB speech spectral features can be extracted for each speech frame of a NB voice signal and a corresponding WB voice signal. The system 200 can generate mapping functions between the wideband vocoded voice signals and the NB vocoded voice signals stored in the databases, 210 and 220. For example, the mapping unit 222 can learn a feature mapping between a NB vocoded voice signal 130 and a wideband vocoded voice signal 250 during a training. When training is complete, a set of mapping functions are available for extending voice bandwidth. During deployment, for example during the decoding of a narrowband voice signal 130 of FIG. 1, the mapping functions can be applied to features of the narrowband vocoded voice signal 130 for generating a WB vocoded voice signal 150. Briefly referring back to FIG. 3, the GMM 222, which inherently provides the mapping, can be trained on the NB vocoded voice database 210 and the WB vocoded voice database 220. For example, during training, a plurality of WB vocoded voice signals and a plurality of NB vocoded voice signals are presented to the mapping unit 222 for learning statistics associated with the transformation between NB features 143 and WB features 147.

Understandably, bandwidth extension is based on the assumption that the NB speech correlates closely with WB voice signal. To ensure an accurate feature mapping, the voice signals used in training are reflective of the voice signals used during deployment. For example, the quality of the voice used during the training has a significant impact on the quality of the bandwidth extension. That is, good quality bandwidth extension of speech is possible when the feature mappings are an accurate representation of the voice signal undergoing the bandwidth extension. That is, the voice signal used during training is characteristic of the voice signal used for bandwidth extension. As an example, feature mappings can be generated for non-vocoded NB speech and non-vocoded wideband speech. The feature mappings are accurate when the mappings are applied to non-vocoded NB speech. However, applying the non-vocoded mappings to vocoded NB speech can result in anomalies which can deteriorate speech quality. Accordingly, using the same type of speech (vocoded or non-vocoded) should be used during training. This includes using vocoded speech for training the GMM 222 when extending the bandwidth of NB vocoded speech.

However, in the case of vocoded speech, WB vocoded speech is not generally available. For example, referring back to FIG. 1, the decoder 120 can only generate NB vocoded speech; that is, it cannot generate WB vocoded speech which can be used for training in FIG. 3. The decoder 120 has an established voice bandwidth based on the sampling frequency established by the communication system. In the case of telephone speech, the decoder establishes a sampling frequency of 8 KHz, thus constraining the voice bandwidth to 4 KHz. Accordingly, a wideband (0-8 KHz) vocoded voice signal is not available for training the GMM (see FIG. 3). Also, the decoder 120 cannot be configured to produce wideband speech. Understandably, the objective of the decoder 120 is to compress speech which results in a narrowband voice signal. Because a WB vocoded voice signal is not available, one may consider using a WB non-vocoded signal for training. However, If a wideband non-vocoded voice signal is used to train feature mappings for a NB vocoded voice signal, anomalies and a sacrifice in speech quality bandwidth extension can be expected due to a lack of correlation between the two sets of speech databases.

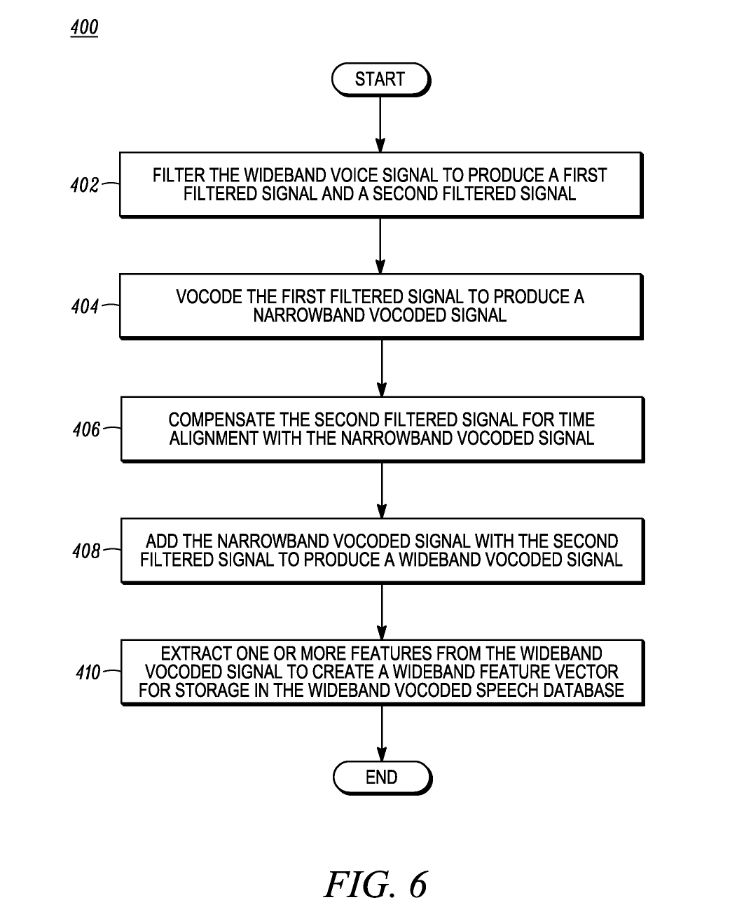

Understandably, one aspect of the invention is directed to creating a WB vocoded voice database 220 from NB vocoded speech. That is, WB vocoded voice signals are artificially created from NB vocoded speech to provide WB vocoded voice signals for training the GMMs (222) and creating mapping functions. For example, referring to FIG. 5 and FIG. 6, a block diagram of a system 300 and a corresponding method 400 for creating wideband vocoded voice signals for use in training is shown. The system 300 can include more or less than the number of components shown. Accordingly. The method 400 associated with the system 300 can be practiced with more or less that the number of steps shown. Moreover, the method 400 is not limited to the order in which the steps are listed in the method 400.

The system 300 can include a filter 301 for filtering the wideband voice signal to produce a first filtered signal 306 and a second filtered signal 331 corresponding to step 402. The system can include a vocoder 308 for vocoding the first filtered signal to produce a narrowband vocoded signal 130 corresponding to step 404. The vocoder can be at least one of a VSELP, AMBE, AMD, and CELP type vocoder. The system 300 can include a compensator 326 for time aligning the second filtered signal 331 with the narrowband vocoded signal 130 corresponding to step 406. The system can include a combiner 335 for adding the narrowband vocoded signal 130 with the compensated second filtered signal 340 to produce a wideband vocoded signal 150 for storage in the wideband vocoded speech database, corresponding to step 408. Alternatively, one or more features of the wideband vocoded signal 150 can be extracted to create a wideband feature vector for storage in the wideband vocoded speech database, as shown at step 410.

Upon creation of the WB vocoded voice database, training can take place. For example, referring back to FIG. 4, the GMM 222 can learn the mapping between NB vocoded features in the NB vocoded database 210 and the WB vocoded features in the artificially created WB vocoded database 220. In this regard, close correlation exists between the NB vocoded features and the WB vocoded features to improve the quality of the feature mapping. Consequently, during deployment, NB vocoded speech undergoing voice bandwidth expansion using mapping functions trained on NB vocoded voice and WB vocoded voice will be of a higher quality. That is, the correlation between the NB vocoded voice and the WB vocoded voice is higher which leads to higher output quality having fewer audio artifacts.

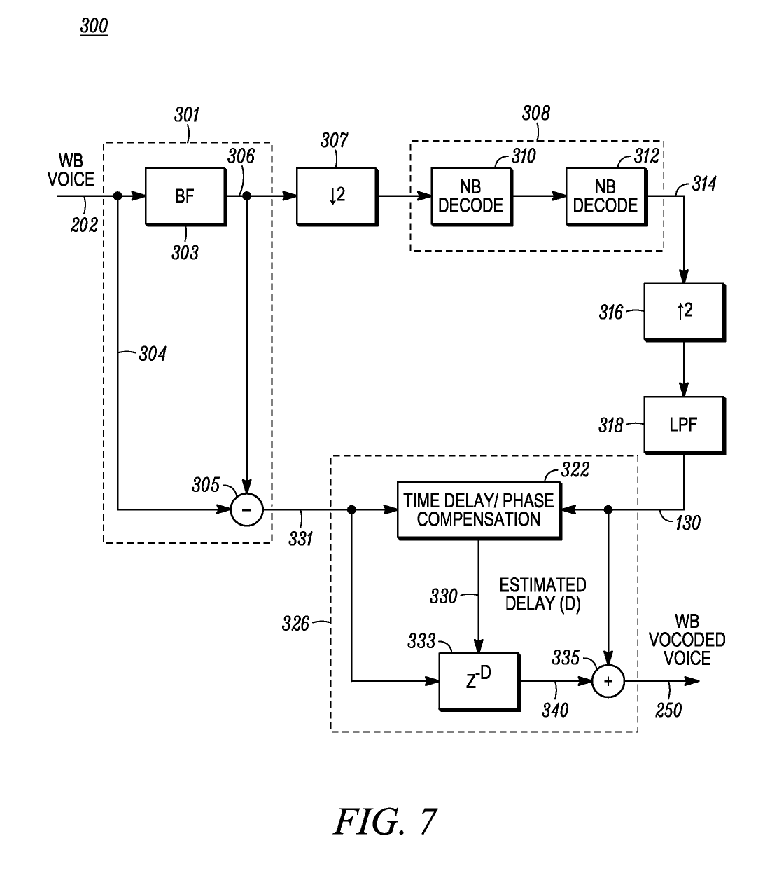

Referring to FIG. 7, further details of the system 300 of FIG. 5 are shown. To describe the system 300, reference may be made to FIGS. 1 to 5, although it is understood that the components of the system 300 can be implemented in any other suitable device or system using other suitable components than those shown in FIG. 7. In particular, the system 300 generates a wideband vocoded speech database for use training a bandwidth extension system. The filter 301 (See FIG. 6) can include a band filter (BP) 303 for filtering the WB speech 202 into one or more frequency bands of a banded signal 306, and a subtractor 305 for subtracting the banded signal 306 from the wideband signal 202 to produce the second filtered signal. The BP can be a low-pass filter, a high-pass filter, a band-pass filter or a band-stop filter. In the configuration shown, the BP 303 is a low-pass filter that filters the WB speech 202 to a 140-3.4 KHz range for conditioning the speech to a bandwidth required by the vocoder 308.

A down sampler 307 is also included to lower the sampling rate of the banded signal 306. For example, the WB speech sampled at 16 KHz can be down-sampled by a factor of 2 for providing a sampling frequency of 8 KHz. Understandably, the vocoder 308 input specifications may require 8 KHz speech having a bandwidth of 300-3.4 KHz. Various vocoders can have different input specifications which allow for different sampling and bandwidth requirements which are herein contemplated. Aspects of the invention are not limited to the specifications provided which are presented merely as example. The bandwidth and sampling rate may vary for different vocoders. For example, the bandwidth may extend from 140 Hz to 3.8 KHz. The down-sampled and bandlimited WB speech can be processed by the vocoder 308 to produce NB vocoded voice 314. The vocoder 308 can include an encoder section 310 and a decoder section 308. Understandably, the vocoder 308 compresses and quantizes the speech which can reduce data transmission requirements for a compromise in speech quality. The up-sampler 316 can resample the NB vocoded voice 314 to the WB sample rate. For example, the NB vocoded voice 314 having a sampling rate of 8 KHz can be up-sampled to 16 KHz. The LPF 318 can be applied to the up-sampled NB vocoded voice to suppress aliased frequency components resulting from the up-sampling. For example, the NB vocoded voice can be bandlimited to 8 KHz having an effective sampling rate of 16 KHz.

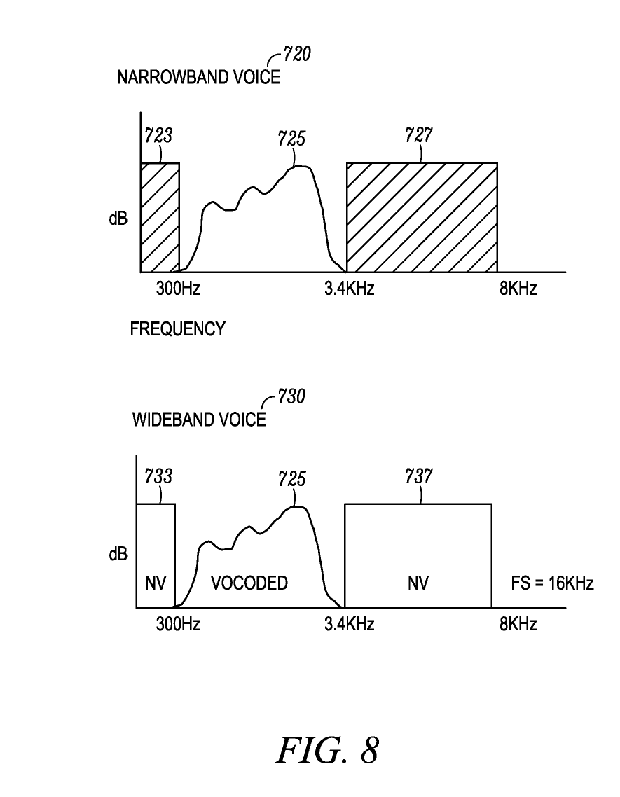

Briefly referring to FIG. 8, a frequency analysis of a portion of NB voice 720 spectrum and WB voice spectrum 730 is shown. The NB voice spectrum 720 corresponds to 130 of FIG. 7, and the WB voice spectrum 730 corresponds to 250 of FIG. 7. The frequency spectrum of NB voice 720 shows a low frequency region of speech 723, a mid-frequency region of speech 725, and a high frequency region of speech 727. Notably, the low-frequency region starts at a cut-off frequency of 300 KHz which corresponds to the upper band cut off of the vocoder 308. The high-frequency region ends at a cut-off frequency of 3.4 KHz corresponding to the upper band cut off of the vocoder 308. Understandably, the shaded regions 723 and 727 are those frequency components not included in the NB vocoded voice signal 130. That is, the NB vocoded voice signal is represented only by the frequency region 725 due to aspects of the vocoding process. Clearly, the NB vocoded voice 130 is missing low frequency and high frequency speech components that were originally available in the WB voice 202 (See FIG. 7).

One aspect of bandwidth extension is to restore the missing frequency components. For example, the output WB vocoded voice signal 250 (See FIG. 7) of the wideband voice spectrum 730 shows the non-vocoded (NV) WB low-frequency region 733 and the non-vocoded WB high frequency region 737. Notably, the WB voice spectrum 730 preserves the voice spectrum 725 of the vocoded voice 130 and appends the WB low-band frequencies and WB high-band frequencies. That is, the voice regions corresponding to the vocoder bandwidth 300 to 3.4 KHz are the same voice regions in the output WB vocoded voice signal 250 (See FIG. 7).

Returning to the filter 301 of FIG. 7, the banded signal 306 is subtracted from the WB speech 202 to produce the second filtered signal 331. As a result of the subtraction, the second filtered signal 331 does not include frequency components already handled by the vocoder 308. That is, the second filtered signal only includes those frequency components outside the bandwidth of the vocoder 308 As shown in FIG. 8, this corresponds to the low (723) and high (727) frequency regions. The subtraction isolates low frequency region (733) and high-frequency region (737) of the WB speech signal 202.

The compensator 322 time aligns the second filtered signal 331 with the NB vocoded voice signal 130. Understandably, the vocoder 308 can introduce delays in processing which result in misalignment between the second filtered signal 331 with the NB vocoded voice signal 130. The compensator 322 can estimate a delay 330 between the second filtered signal 331 with the NB vocoded voice signal 130, and time-shift 333 the second filtered signal 331 to be coincident with the NB vocoded voice signal 130. The adder 335 can add the delayed second filtered signal 340 with the NB vocoded voice signal 130 to produce a wideband vocoded output signal 250. Notably, only the speech within the vocoder bandwidth is vocoded. For example, referring to FIG. 8, the WB vocoded voice signal 250 is a composite frequency signal having a non-vocoded low-frequency region 733, a vocoded mid-frequency region 725, and a non-vocoded high-frequency region 737. The WB vocoded voice signal 250 can be stored in the WB vocoded database 220 (See FIG. 4).

Referring back to FIG. 4, the WB vocoded voice signals in the WB vocoded voice database 220 are processed and transformed to this new signal space and used with NB vocoded voice signals during GMM training. In this manner, the WB vocoded voice signals 250 include a vocoded portion which is highly correlated with NB vocoded speech. Accordingly, the increased correlation help remove audio artifacts generated during the bandwidth extension process. Notably, WB vocoded voice signal 250 represents an expected upper bound on the speech quality improvement which can be obtained using bandwidth extension.

Furthermore, while a specific example of feature mapping and GMM training has been described, many such training mechanisms may be employed, and may depend on several factors in the design of the respective system, including vocoder types, bandwidth requirements, sample rates, and vocoder configurations. While the preferred embodiments of the invention have been illustrated and described for creating a wideband vocoder database suitable for training of bandwidth extension systems, it will be clear that the invention is not so limited. Numerous modifications, changes, variations, substitutions and equivalents will occur to those skilled in the art without departing from the spirit and scope of the present invention as defined by the appended claims.

What is claimed is:

1. A method to generate a wideband vocoded speech database suitable for use in training of a bandwidth extension system, comprising:
filtering a wideband voice signal to produce a first filtered signal and a second filtered signal
vocoding the first filtered signal to produce a narrowband vocoded signal;
compensating the second filtered signal for time alignment with the narrowband vocoded signal; and
adding the narrowband vocoded signal with the second filtered signal to produce a wideband vocoded signal.

2. The method of claim 1, further comprising extracting one or more features from the wideband vocoded signal to create a wideband feature vector for storage in the wideband vocoded speech database.

3. The method of claim 1, wherein the filtering further comprises:
band-filtering the wideband signal to produce a banded signal; and
subtracting the banded signal from the wideband signal to produce the second filtered signal.

4. The method of claim 3, wherein the band-filtering includes low-pass filtering, band-pass filtering, or high-pass filtering.

5. The method of claim 1, wherein the vocoding includes:
down-sampling the first filtered signal to produce a down-sampled signal;
vocoding the down-sampled signal to produce a vocoded signal; and
up-sampling the vocoded signal to produce the narrowband vocoded signal.

6. The method of claim 1, wherein the compensating includes:
estimating a delay between the second filtered signal and the narrowband vocoded signal; and
delaying the second filtered signal by the delay for producing a delayed second filtered signal; and
adding the delayed second filtered signal with the narrowband vocoded signal for producing the wideband vocoded signal.

7. The method of claim 3, wherein the band-filtering generates the first filtered signal with a voice bandwidth that corresponds to a vocoder bandwidth of the vocoding.

8. The method of claim 3, wherein the second filtered signal isolates low-frequency components and high-frequency components of the wideband voice signal.

9. The method of claim 1, wherein the vocoding is VSELP, AMBE, AMD, or CELP.

10. A method of training voice bandwidth extension systems based on wideband feature mappings, comprising:
receiving a wideband voice signal;
filtering the wideband voice signal to produce a first filtered signal and a second filtered signal;
vocoding the first filtered signal to produce a narrowband vocoded signal;
adding the narrowband vocoded signal with the second filtered signal to produce a wideband vocoded signal;
comparing wideband vocoded features of the wideband vocoded signal with wideband features of the wideband voice signal; and
generating a mapping function based on one or more statistical differences between the wideband vocoded features and the wideband features,
wherein the mapping function describes changes to the narrowband vocoded signal for extending a bandwidth of the narrowband vocoded signal to generate the wideband vocoded signal.

11. The method of claim 10, wherein the mapping function is one of a Gaussian Mixture Model or a Hidden Markov Model.

12. The method of claim 10, further comprising:
evaluating a speech quality difference between the narrowband vocoded signal and the wideband vocoded signal; and
determining an upper-bound voice quality based on the speech quality difference.

13. The method of claim 10, wherein the features are Linear Prediction Coefficients, Cepstral Coefficients, Mel Cepstral Coefficients, or Reflection Coefficients.

14. A system for extending the bandwidth of narrowband voice, comprising
a decoder for receiving a narrowband vocoded voice signal; and
a processor for converting the narrowband vocoded voice signal to a wideband vocoded voice signal based on one or more mapping functions created during a training of a wideband vocoded speech database.

15. The system of claim 14, wherein the processor maps one or more narrowband vocoded features of the narrowband vocoded voice signal to one or more wideband vocoded features of the wideband vocoded signal.

16. The system of claim 15, wherein the processor samples the narrowband vocoded voice signal at approximately 8 KHz and the wideband vocoded voice signal at approximately 16 KHz.

17. The system of claim 15, wherein the processor further:
acquires a set of narrowband reflection coefficients that represent a spectral envelope from the narrowband vocoded voice signal; and
extends the set of narrowband reflection coefficients to a set of wideband reflection coefficients using one of the mapping functions for generating a wideband vocoded spectral envelope.

18. The system of claim 15, wherein the processor further:
extracts a narrowband excitation signal from the narrowband vocoded voice signal using a set of wideband reflection coefficients; and
extends the narrowband excitation signal to a wideband vocoded excitation signal using modulation and filtering.

19. The system of claim 15, wherein the processor further:
combines a wideband vocoded excitation signal with a wideband vocoded spectral envelope to generate a wideband voice signal.

20. The system of claim 15, wherein the processor further:
evaluates a speech quality difference between the narrowband vocoded voice signal and the wideband vocoded voice signal; and
determines an upper-bound voice quality based on the speech quality difference.
